(19) United States
(12) Patent Application Publication
(10) Pub. No.: US 2026/0360082 A1
(43) Pub. Date: Nov. 12, 2026

(54) SYSTEMS AND METHODS FOR OPTIMIZED MAP LAYOUT

(71) Applicant: Siemens Mobility, Inc., New York, NY (US)

(72) Inventors: Heinrich Helmut Degen, Plainsboro, NJ (US); Hüseyin Avsar, Schwülper (DE); John Tyler, Calgary (CA)

(73) Assignee: Siemens Mobility, Inc., New York, NY (US)

(21) Appl. No.: 19/202,526

(22) Filed: May 8, 2025

(51) Int. Cl. G06T 17/05; G06Q 50/16

(52) U.S. Cl. CPC G06T 17/05; G06Q 50/16

(57) ABSTRACT

A method for optimizing a layout of a schematic map includes accessing and scanning a map specification comprising map elements of a schematic map, performing a comparison between the map elements and unbreakable map unit rules, assigning unbreakable map units to the map elements based on the unbreakable map unit rules, accessing map real estate parameters including a display layout and display characteristics, optimizing a map layout for the schematic map corresponding to the display layout and the display characteristics and in accordance with the assigned unbreakable map units, and rendering on a display the schematic map with the optimized map layout, wherein the display comprises multiple display devices, wherein the display layout comprises an organization of the multiple display devices, and wherein the display characteristics comprise display sizes and display resolutions.

### TECHNICAL FIELD

Aspects of the present disclosure generally relate to systems and methods for an optimized map layout.

### Background Art

Many application domains use maps to indicate locations or directions of items. One type of map is a schematic map. A schematic map is as simplified representation of a geographic area that emphasizes locations of elements and their connections and is optimized for a specific map canvas. Directions, e.g., north, south, and distances are abstracted and may deviate from representations on geographic maps. Examples of schematic maps are transit maps, electrical diagrams, network diagrams, and process flows.

Today, a layout of schematic maps, particularly complex schematic maps, is drawn manually. If a schematic map changes, the layout of the schematic map, relative to the map canvas, need to be modified manually. This requires significant manual labor.

### SUMMARY

Methods and systems for optimized map layouts are described herein. A first aspect of the present disclosure provides a method for optimizing a layout of a schematic map comprising, by a computing system, accessing and scanning a map specification comprising map elements of a schematic map, performing a comparison between the map elements and unbreakable map unit rules, assigning unbreakable map units to the map elements based on the unbreakable map unit rules, accessing map real estate parameters of available map real estate, the parameters including a display layout and display characteristics, optimizing a map layout for the schematic map corresponding to the display layout and the display characteristics and in accordance with the assigned unbreakable map units, and rendering on a display the schematic map with the optimized map layout, wherein the display comprises multiple display devices, wherein the display layout comprises an organization of the multiple display devices, and wherein the display characteristics comprise display sizes and display resolutions.

A second aspect of the present disclosure provides a system comprising a processor, and a non-transitory computer readable medium comprising instructions that when executed by the processor cause a computing system to access and scan a map specification comprising map elements of a schematic map, perform a comparison between the map elements and unbreakable map unit rules, assign unbreakable map units to the map elements based on the unbreakable map unit rules, access map real estate parameters including a display layout and display characteristics, optimize a map layout for the schematic map corresponding to the display layout and the display characteristics and in accordance with the assigned unbreakable map units, and render on a display the schematic map with the optimized map layout, wherein the display comprises multiple display devices, wherein the display layout comprises an organization of the multiple display devices, and wherein the display characteristics comprise display sizes and display resolutions.

A third aspect of the present disclosure provides a non-transitory computer readable medium storing executable instructions, which, when executed by a computer, perform a method for optimizing a layout of a schematic map as described herein.

### BRIEF DESCRIPTION OF THE DRAWINGS

FIG. 1 illustrates schematics of different map real estates in accordance with exemplary embodiments of the present disclosure.

FIG. 2 illustrates schematics of different map specifications in accordance with exemplary embodiments of the present disclosure.

FIG. 3 illustrates schematics of different map layouts assigned to different display layouts in accordance with exemplary embodiments of the present disclosure.

FIG. 4 illustrates a simplified flow chart for a method for optimizing a map layout in accordance with an exemplary embodiment of the present disclosure.

FIGS. 5,6 and 7, illustrate flow charts of a first phase for a method for optimizing a map layout in accordance with an exemplary embodiment of the present disclosure.

FIG. 8 illustrates a schematic of a map specification with unbreakable map units in accordance with an exemplary embodiment of the present disclosure.

FIG. 9 illustrates a flow chart of a second phase for a method for optimizing a map layout in accordance with an exemplary embodiment of the present disclosure.

FIG. 10 illustrates an example of a computing system that supports optimizing a map layout in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of systems and methods for optimizing map layouts, for example in connection with train control and dispatch systems.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

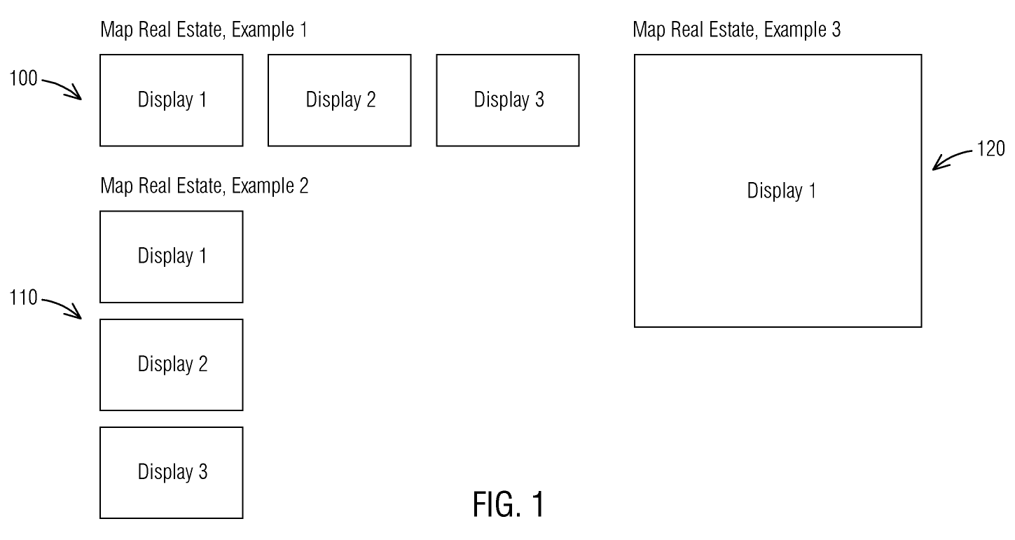

FIG. 1 illustrates schematics of different map real estates in accordance with exemplary embodiments of the present disclosure.

### Map Real Estate

When optimizing a map layout, a key consideration is the available map real estate. The map real estate is understood here as an available display area, their physical and virtual sizes, expressed as resolution, and a layout of multiple displays when available. Examples include map real estate 100 including multiple displays arranged horizontally, map real estate 110 including multiple displays arranged vertically and map real estate 120 including a single display of a specific size. In another example, map real estate can consist of a matrix of screens, i. e., vertically and horizontally organized screens. In a matrix of screens or displays, multiple screens or displays are arranged in multiple columns and rows. Optimizing the layout of a schematic map means to optimize the layout for a given map real estate 100, 110 and 120.

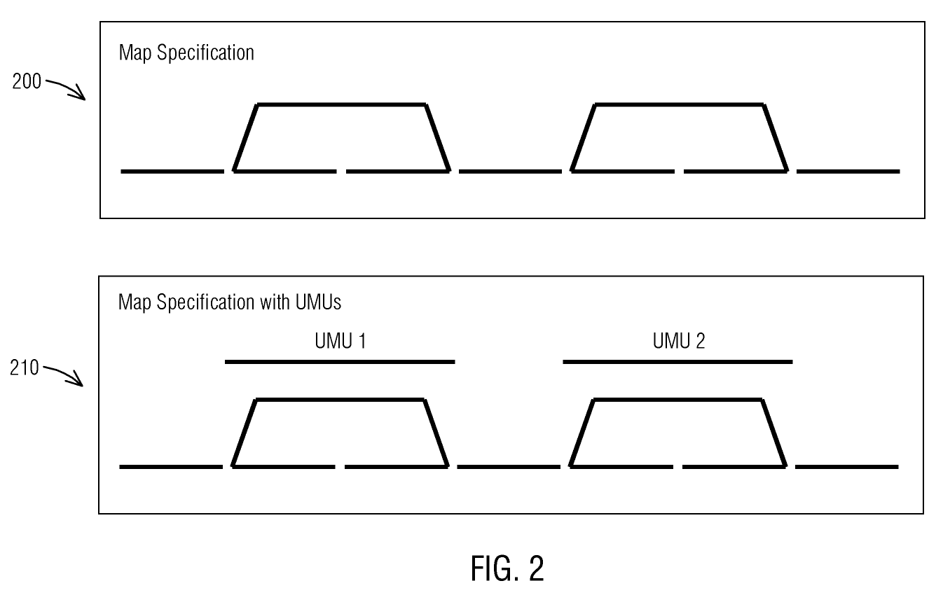

FIG. 2 illustrates schematics of different map specifications in accordance with exemplary embodiments of the present disclosure.

### Unbreakable Map Unit, herein referred to as “UMU” or “UMUs”

A map is specified by map elements and their relationships. Another key consideration for optimizing a map for a given map real estate is which map parts can be broken (separated) and which map parts cannot be broken. For simplicity, we focus here on the map parts that cannot be broken. Map part(s) that cannot be broken is/are called herein an “unbreakable map unit”, also referred to as UMU. Unbreakable map units are to be displayed as one item, for example on one single display device and not be broken or distributed over multiple displays, and/or within one row and not broken over multiple rows of one display. As used herein, the term ‘row’ refers to a horizontal arrangement or line on a screen or display.

FIG. 2 illustrates examples of a map specifications 200, 210 with map elements. In an example, the map elements of specifications 200, 210 show elements of a train control and dispatch system, more specifically track lines including sidings. Map specification 200 is without UMUs, whereas map specification 210 includes map elements that are identified as UMUs. The sidings are identified and designated as UMU 1 and UMU 2. This means that these map elements are not separated when creating or adjusting the map layout of the map specification.

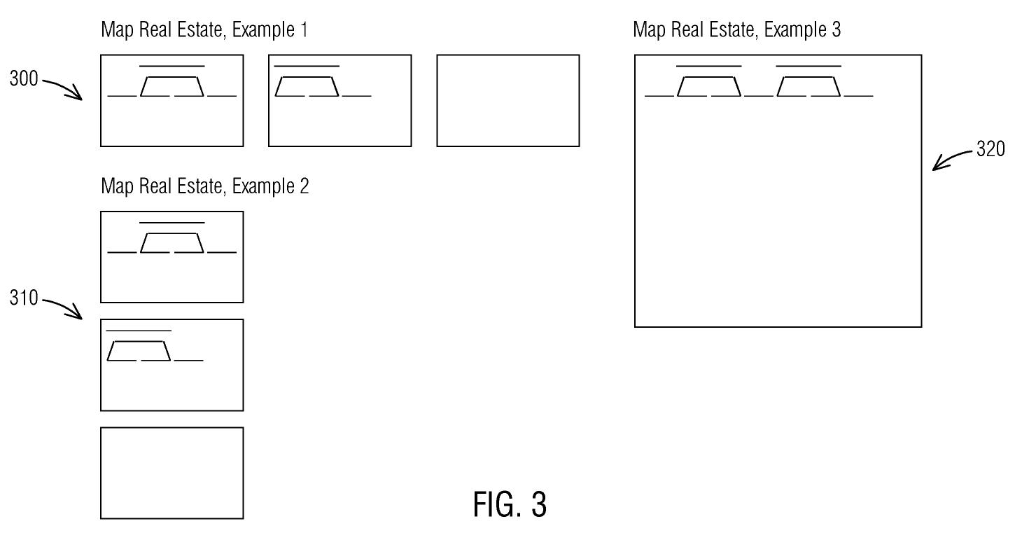

FIG. 3 illustrates schematics of different map layouts assigned to different display layouts in accordance with exemplary embodiments of the present disclosure.

### Map Parts

When optimizing a map layout for a given map real estate, e. g. estates 100, 110, 120 of FIG. 1, map elements will be assigned to the display(s). The map will be broken into map parts. A map part is a set of map elements that is displayed on a display without being broken. The introduction of UMUs defines which elements of a map belong to a map part. All elements of an UMU always belong to the same map part. FIG. 3 illustrates examples 300, 310 and 320 with map parts and how they are assigned to different displays (map real estates).

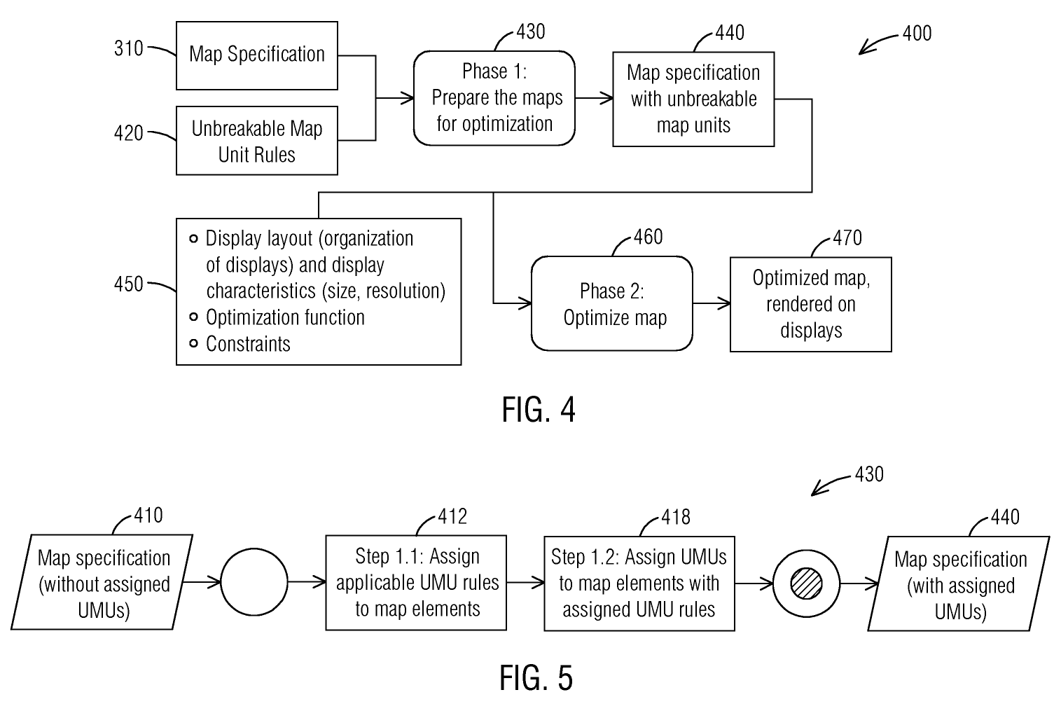

FIG. 4 illustrates a simplified flow chart for a method 400 for optimizing a map layout in accordance with an exemplary embodiment of the present disclosure.

In accordance with an exemplary embodiment of the present disclosure, the method 400 for optimizing a layout of a schematic map comprises
automatically identifying UMUs for a given map specification (act 430 - phase 1) and
optimizing a map layout for a given map real estate (act 460 - phase 2).

Inputs into phase 1 (430) include a map specification 410 (without unbreakable map units), and unbreakable map unit rules 420. Generally, the map specification 410 is a set of rules and guidelines that define details of how a map should be created, including its content, scale, level of detail, visual style and data sources, essentially outlining exact parameters for producing a particular map, whether it is printed or digital. The unbreakable map unit rules 420 define which map elements or group of map elements are to become unbreakable, i. e., not to be separated when producing the map.

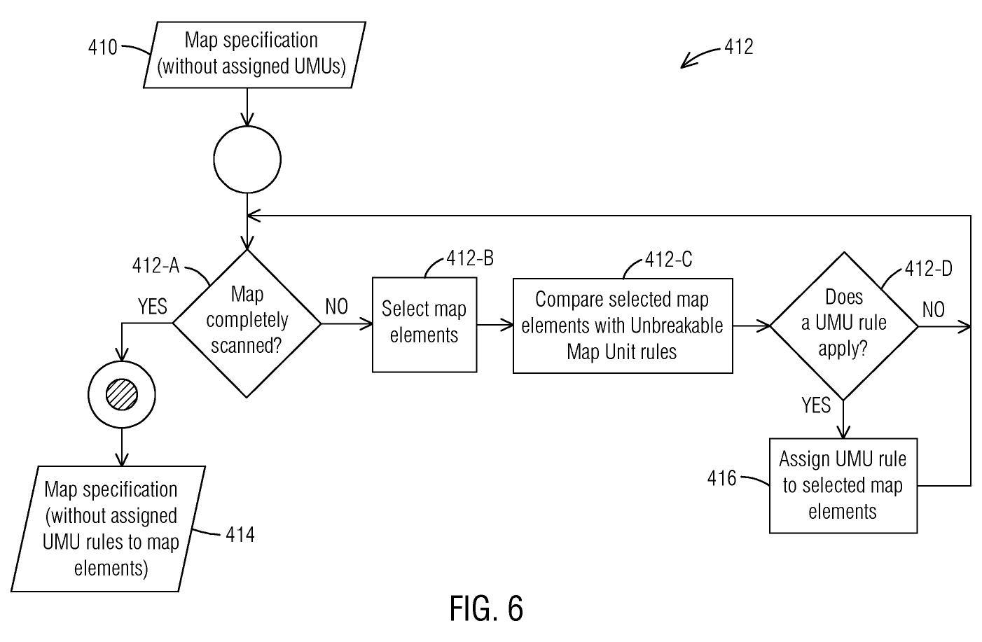

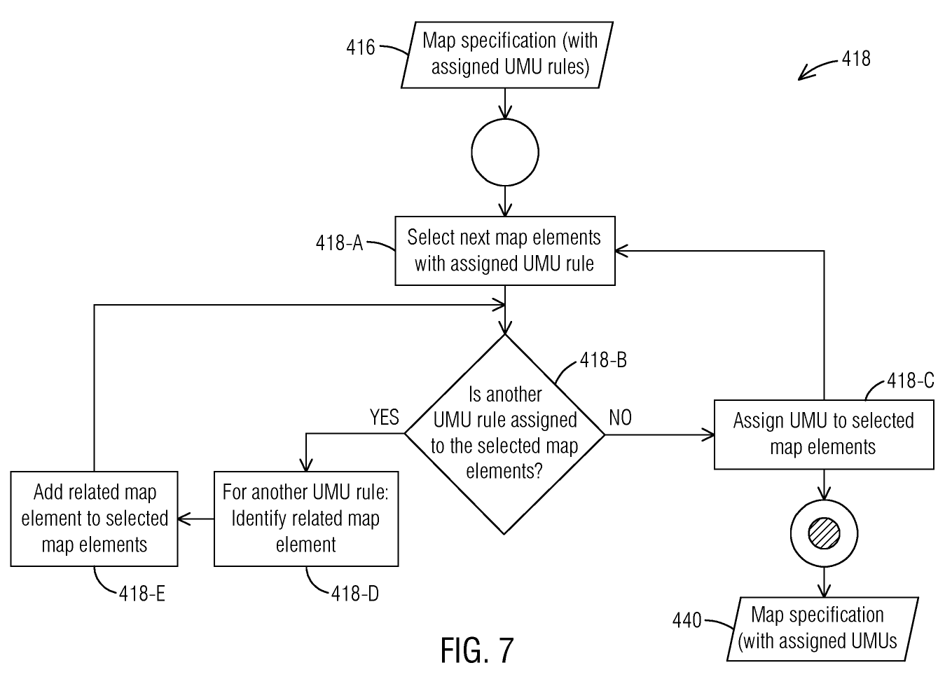

In phase 1 (430), map elements or group(s) of map elements that match with one or more of the unbreakable map unit rules are identified and marked as an UMUs. In addition, a user has an option to manually create unbreakable map units and/or unbreakable map unit rules. Phase 1 is described in more detail with reference to FIGS. 5,6 and 7, . Output 440 of phase 1 includes a map specification with unbreakable map units.

With respect to phase 2 (460), inputs include the specification with unbreakable map units (output 440 of phase 1). Further inputs 450 include:
map real estate parameters, such as organization of displays (see examples FIG. 1 and display characteristics, such as size and resolution of the display(s),
optimization goals, such as reduction of unused areas in a layout/display, and constraints.
Constraints include for example that certain maps should be next to each other, linear or z-map, grid layout, size of track elements, etc.

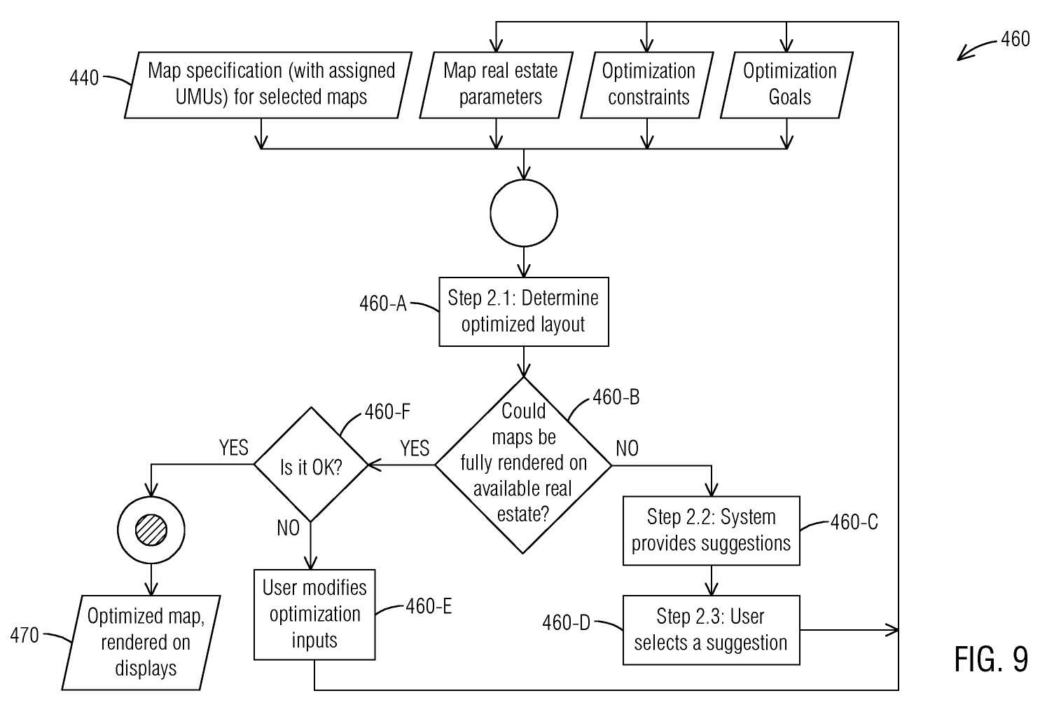

In phase 2, the schematic map is optimized for the inputs 450, wherein output 470 includes an optimized map that is rendered on display(s). Phase 2 is described in more detail with reference to FIG. 9.

FIGS. 5,6 and 7, illustrate flow charts of phase 1 (act 430) as depicted in FIG. 4 for a method for optimizing a map layout in accordance with exemplary embodiments of the present disclosure.

FIG. 5 illustrates a flow chart of phase 1 (act 430) to identify and assign unbreakable map units to a map specification, FIG. 6 illustrates a flow chart for step 1.1 of act 430, and FIG. 7 illustrates a flow chart of step 1.2 of act 430 for optimizing a map layout.

With reference to FIG. 5, as noted above, phase 1 (act 430) comprises automatically identifying UMUs for a given map specification. Input 410 includes a map specification, without assigned unbreakable map units. In step 1.1 (act 412), unbreakable map unit rules (“UMU rules”) are applied/assigned to the map specification, more specifically to all map elements of the schematic map. In step 1.2 (act 418), UMUs are assigned to one or more map elements where the unbreakable map unit rules apply. The output 440 comprises the map specification with assigned UMUs.

With reference to FIG. 6, step 1.1 (act 412) is described in detail. Input 410 includes the map specification. Act 412 comprises accessing and scanning (examining) the map specification of the schematic map. Is the map specification completely scanned without map elements being selected (decision block 412-A), act 412 ends, wherein output 414 includes the map specification without assigned unbreakable map unit rules to the map elements. On the other hand, when the map specification has not been (fully) scanned, scanning continues and in act 412-B, map elements are selected. Act 412-C comprises performing a comparison between the selected map elements and unbreakable map unit rules. If one or more of the unbreakable map unit rules apply (decision block 412-D), the respective unbreakable map unit rule(s) are identified and assigned to the selected map elements (output 416).

With reference to FIG. 7, step 1.2 (act 418) is described in detail. Following output 416, that is the map specification with assigned unbreakable map unit rules (see end of FIG. 6), the method includes selecting next map elements with assigned unbreakable map unit rule (act 418-A). Decision block 418-B comprises a determination to find out whether another unbreakable map unit rule is assigned to the selected map elements. If there is not another unbreakable map unit rule assigned to the selected map elements, which means that there is one rule assigned, then this one rule is assigned to the map elements (act 418-C). If there are multiple unbreakable map unit rules assigned or identified for certain map elements (act 418-D), then all applicable rules are assigned to the map elements (act 418-E). If multiple rules define multiple, overlapping group of map elements as UMUs, the superset of group of map elements become unbreakable. Output 440 comprises a map specification with unbreakable map units.

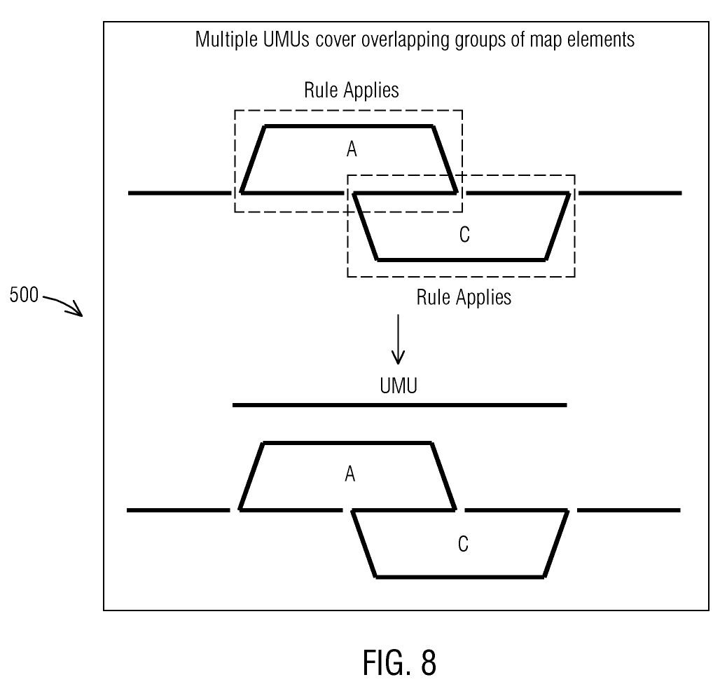

FIG. 8 illustrates a schematic 500 of a map specification with unbreakable map units in accordance with an exemplary embodiment of the present disclosure. As schematic 500 shows, if unbreakable map unit rules apply to overlapping groups of map elements, the superset of identified group of map elements becomes one UMU.

FIG. 9 illustrates a flow chart of phase 2 (act 460) as depicted in FIG. 4 for a method for optimizing a map layout in accordance with an exemplary embodiment of the present disclosure.

In accordance with an exemplary embodiment of the present disclosure, phase 2 (act 460) for a method for optimizing a layout of a schematic map comprises optimizing a map layout for a given map real estate. More specifically, the method includes identifying and prioritizing causal factors.

Inputs include the map specification 440 with UMUs (output 440 of phase 1). Further inputs 450 for phase 2 comprise
map real estate parameters, such as organization of displays (see examples FIG. 1 and display characteristics, such as size and resolution of the display(s),
optimization goals, such as reduction of unused areas in a layout/display, and
optimization constraints, for example that certain maps should be next to each other, linear or z-map, grid layout, size of track elements, etc.

Maps with defined and assigned UMUs unlock the opportunity to optimize the layout rendered on one or more displays. To generate an optimized map that can be rendered on display(s), the optimization function (act 460) requires the inputs 440, 450 as mentioned above, which include a map specification for selected maps, map real estate parameters, optimization constraints, and optimization goals.

A first step (step 2.1, act 460-A) comprises determining an optimized map layout and checking whether the amount of information to be displayed fits within the available map real estate (act 460-B). For example, an algorithm determines an optimized layout for selected maps on the available map real estate according to the optimization constraints and optimization goals.

In a second step (step 2.2), if the required map area exceeds the available map real estate, the algorithm determines options (input parameters) that may be changed to fit the selected maps on the map real estate (act 460-C). If the maps cannot be fully rendered on the available real estate, the system will generate suggestions to solve the problem (act 460-C). These options will then be offered to a user (step 2.3, act 460-D).

The user selects one of the suggested options, and the algorithm described with reference to step 2.1 runs/executes again. Once the maps are fully rendered on the available real estate, the user can modify the optimization inputs to adapt the layout according to their preferences (act 460-E). If the user is not satisfied with the layout rendered on the displays, the user can modify the optimization inputs, and the process will repeat, starting from step 2.1. The result of this process is an optimized map that is rendered on displays (output 470).

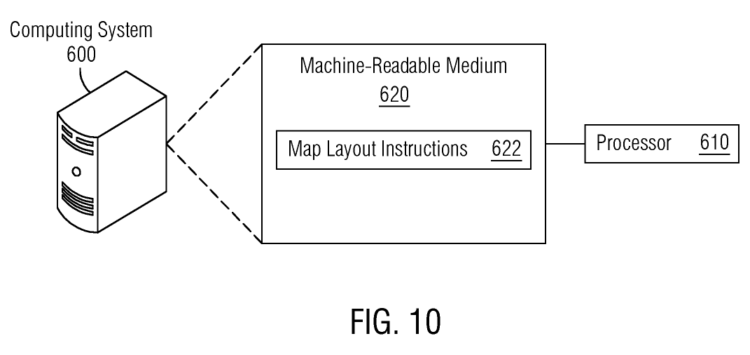

While the method 400 and sub-routines 412, 418, 430 and 460 are described herein as a series of acts that are performed in a sequence, it is to be understood that the method and sub-routines may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein. The methods are performed by a computing system 600 as described herein with reference to FIG. 10.

FIG. 10 illustrates an example of a computing system 600 that supports optimizing a map layout in accordance with an exemplary embodiment of the present disclosure.

The computing system 600 may include a processor 610, which may take the form of a single or multiple processors. The processor(s) 610 may include a central processing unit (CPU), microprocessor, or any hardware device suitable for executing instructions stored on a machine-readable medium. The computing system 600 may include a machine-readable medium 620. The machine-readable medium 620 may take the form of any non-transitory electronic, magnetic, optical, or other physical storage device that stores executable instructions, such as the map layout instructions 622. As such, the machine-readable medium 620 may be, for example, Random Access Memory (RAM) such as a dynamic RAM (DRAM), flash memory, spin-transfer torque memory, an Electrically Erasable Programmable Read-Only Memory (EEPROM), a storage drive, an optical disk, and the like.

The computing system 600 may execute instructions stored on the machine-readable medium 620 through the processor 610. Executing the instructions (e. g., the instructions 622) may cause the computing system 600 to perform or implement the map layout optimization technology described herein.

For example, execution of the map layout instructions 622 by the processor 610 may cause the computing system 600 to access and scan a map specification comprising map elements of a schematic map, perform a comparison between the map elements and unbreakable map unit rules, assign unbreakable map units to the map elements based on the unbreakable map unit rules, access map real estate parameters including a display layout and display characteristics, optimize a map layout for the schematic map corresponding to the display layout and the display characteristics and in accordance with the assigned unbreakable map units, and render on a display the schematic map with the optimized map layout.

The systems, methods, devices, and logic described above may be implemented in many ways in many different combinations of hardware, logic, circuitry, and executable instructions stored on a machine-readable medium. A product, such as a computer program product, may include a storage medium and machine-readable instructions stored on the medium, which when executed in an endpoint, computer system, or other device, cause the device to perform operations according to any of the description above.

The processing capability of the systems, devices, and engines described herein may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many ways, and may be implemented in many ways, including data structures such as linked lists, hash tables, or implicit storage mechanisms. Programs may be parts (e.g., subroutines) of a single program, separate programs, distributed across several memories and processors, or implemented in many ways, such as in a library (e.g., a shared library).

1. A method for optimizing a layout of a schematic map comprising:
by a computing system:
accessing and scanning a map specification comprising map elements of a schematic map,
performing a comparison between the map elements and unbreakable map unit rules,
assigning unbreakable map units to the map elements based on the unbreakable map unit rules,
accessing map real estate parameters of available map real estate, the parameters including a display layout and display characteristics,
optimizing a map layout for the schematic map corresponding to the display layout and the display characteristics and in accordance with the assigned unbreakable map units, and
rendering on a display the schematic map with the optimized map layout,
wherein the display comprises multiple display devices,
wherein the display layout comprises an organization of the multiple display devices, and
wherein the display characteristics comprise display sizes and display resolutions.

2. The method of claim 1,
wherein the unbreakable map unit rules define groups of conjoined map elements.

3. The method of claim 2,
wherein a group of conjoined map elements is displayed on a single display device without being distributed over multiple display devices.

4. The method of claim 2,
wherein a group of conjoined map elements is displayed on a single display device in a single row.

5. The method of claim 1,
wherein the optimizing of the map layout comprises:
adjusting the map layout for the schematic map according to optimizing constraints and optimization goals including reducing unused areas in the display layout.

6. The method of claim 1,
wherein the optimizing of the map layout comprises:
checking whether the schematic map fits within the available map real estate,
creating options including optimization input parameters to fit the schematic map on the map real estate, and
receiving user input comprising a selected option.

7. The method of claim 1, further comprising:
receiving user input comprising manually created unbreakable map units.

8. A system comprising:
a processor, and
a non-transitory computer readable medium comprising instructions that when executed by the processor cause a computing system to:
access and scan a map specification comprising map elements of a schematic map,
perform a comparison between the map elements and unbreakable map unit rules,
assign unbreakable map units to the map elements based on the unbreakable map unit rules,
access map real estate parameters including a display layout and display characteristics,
optimize a map layout for the schematic map corresponding to the display layout and the display characteristics and in accordance with the assigned unbreakable map units, and
render on a display the schematic map with the optimized map layout,
wherein the display comprises multiple display devices,
wherein the display layout comprises an organization of the multiple display devices, and
wherein the display characteristics comprise display sizes and display resolutions.

9. The system of claim 8,
wherein the unbreakable map unit rules define groups of conjoined map elements.

10. The system of claim 9,
wherein a group of conjoined map elements is displayed on a single display device without being distributed over multiple display devices.

11. The system of claim 9,
wherein a group of conjoined map elements is displayed on a single display device in a single row.

12. The system of claim 8,
wherein the instructions further cause the computing system to
adjust the map layout for the schematic map according to optimizing constraints and optimization goals including reducing unused areas in the display layout.

13. The system of claim 8,
wherein the instructions further cause the computing system to
check whether the schematic map fits within the available map real estate,
create options including optimization input parameters to fit the schematic map on the map real estate, and
receive user input comprising a selected option.

14. The system of claim 1,
wherein the instructions further cause the computing system to
receive user input comprising manually created unbreakable map units.

15. A non-transitory computer readable medium storing executable instructions, which, when executed by a computer system, perform a method for optimizing a layout of a schematic map as claimed in claim 1.
